(19) United States
(12) Patent Application Publication
(10) Pub. No.: US 2023/0130775 A1
(43) Pub. Date: Apr. 27, 2023

(54) FUEL INJECTOR FOR INTERNAL COMBUSTION ENGINES

(71) Applicant: Robert Bosch GmbH, Stuttgart (DE)

(72) Inventors: Andreas Koeninger, Neulingen-Goebrichen (DE); Fabian Wolf, Renningen (DE); Gerhard Suenderhauf, Tiefenbronn (DE); Knut Kristian Baadshaug, Kongsberg, Buskerud (NO)

(21) Appl. No.: 17/627,923

(22) PCT Filed: May 27, 2020
(86) PCT No.: PCT/EP2020/064627

§ 371 Date: Jun. 3, 2022

(30) Foreign Application Priority Data
Jul. 18, 2019 (DE) 10 2019 210 631.5

(51) Int. Cl. F02M 61/06; F02M 61/18

(52) U.S. Cl. CPC F02M 61/06; F02M 61/1833

(57) ABSTRACT

The invention relates to a fuel injector (10) for internal combustion engines, comprising a nozzle body (12), in which there is formed a blind bore (14), from which at least one injection opening (22) starts, and comprising a nozzle needle (26; 26a to 26g) which is arranged so as to be movable longitudinally in the nozzle body (12), with a sealing face (28) formed on the side facing towards the blind bore (14), by means of which sealing face the nozzle needle (26; 26a to 26g) interacts with a seat face (17) of the nozzle body (12) in order to control a flow of fuel to the at least one injection opening (22), and comprising a needle tip (34), which has a first edge (41) miming radially around a longitudinal axis (15) and having a first diameter (D₁), which first edge is adjoined in the direction of the base of the blind bore (20) by a second edge (42) miming radially around the longitudinal axis (15) and having a second diameter (D₂).

### BACKGROUND OF THE INVENTION

The invention relates to a fuel injector for internal combustion engines of the kind used, in particular, as a component of a “common rail” injection system for self-ignition internal combustion engines for applications with relatively high maximum flow or injection rates.

A fuel injector for internal combustion engines is known from DE 10 2016 116 690 A1. The known fuel injector is distinguished by a nozzle needle with a needle tip which, below a section of conical design in the direction of a blind hole bottom of a nozzle body, has a cylindrical section with two edges extending radially around a longitudinal axis of the nozzle needle, wherein, in a closed position of the nozzle needle, the second edge, that adjacent to the blind hole bottom, is arranged below a lower inlet edge of an injection opening, wherein, in a partially open position of the nozzle needle, the first edge, that further away from the blind hole bottom, is arranged below an upper inlet edge of the injection opening, and wherein, in a fully open position of the nozzle needle, the second edge is arranged above the lower inlet edge of the injection opening. Such a design of the needle tip of the nozzle needle is intended, in particular, to permit a stable flow between the nozzle needle, the blind hole and the injection opening or to avoid unstable flow states. Such unstable flow states can manifest themselves in a tendency for cavitation in the partial stroke range of the nozzle needle and thus, in particular, may also adversely affect quantitative accuracy over the service life of the fuel injector.

### SUMMARY OF THE INVENTION

Apart from the desired properties such as the achievement of a stable flow while at the same time having a low dead volume, the fuel injector according to the invention has the advantage above all that its tendency for cavitation is significantly reduced in a partial stroke range of the nozzle needle, in which the cross-sectional area in the region of the seat between the nozzle needle and the nozzle body is smaller than the cross section of the injection openings below the nozzle seat. In addition, high flow efficiency is achieved in the full-stroke range of the nozzle needle.

According to the invention, the abovementioned advantages in the fuel injector according to the invention are achieved in that the diameter of the nozzle needle in the region of the first edge is greater than the diameter of the nozzle needle in the region of the second edge, and in that a distance between the two edges, when viewed in the direction of the longitudinal axis, corresponds to 0.4 times to 1.6 times a diameter of the injection opening in an inlet region to the blind hole in the non-rounded state of the inlet region.

The general concept of the invention described above can be implemented in different ways in terms of construction in order in each case to achieve specifically beneficial advantages. Thus, in a first design implementation, it is envisaged that the nozzle needle has at least one section of conical design between the two edges of the needle tip.

As an alternative to this, however, it is also possible for the nozzle needle to be of cylindrical design between the two edges.

In yet another design alternative to the last two proposals, provision is made for the nozzle needle to be of convex or concave design between the two edges.

Irrespective of the shape of the nozzle needle in the axial end region or in the region of the needle tip, a further embodiment that is preferred in terms of design provides for the nozzle needle to have a section of cylindrical design between the first edge and the sealing surface on the nozzle seat.

In a further development of the last-mentioned proposal, provision is made for the section of cylindrical design to be adjoined in the direction of the sealing surface on the nozzle body by a section of conical design whose angle with respect to the longitudinal axis of the nozzle needle is greater than the angle between the sealing surface and the longitudinal axis.

In a further development of the last proposal made, it is particularly advantageous if the difference between the two angles on the nozzle needle is less than 8.5°. In particular, this avoids a strong deflection of the fuel flow with correspondingly negative effects.

As an alternative to a section of cylindrical design between the first edge and the sealing surface in the region of the nozzle body, provision can also be made for the nozzle needle to have a section of concave design there.

There are also different possibilities with regard to the design of the nozzle needle below the second edge or in the direction of the bottom of the blind hole. Thus, for example, provision can be made for the second edge to delimit a flat end face of the needle tip. As an alternative to this, provision can be made for the needle tip to be of conical design on that side of the second edge which faces away from the first edge.

Irrespective of the specific shape of the nozzle needle described so far, it is also important with regard to flow guidance to configure the design of the nozzle body in an advantageous manner. For this purpose, provision is made, in particular, for the blind hole in the nozzle body to have a cylindrical section which merges into a rounded blind hole bottom, and for the transition between the cylindrical section and the rounded blind hole bottom to be arranged between the upper and lower inlet edges of the injection opening, wherein the longitudinal axis of the injection opening preferably intersects the transition.

A further optimization of the fuel flow in the direction of the injection opening envisages that the injection opening is designed to be rounded in the inlet region to the blind hole.

Further advantages, features and details of the invention will become apparent from the following description of preferred embodiments of the fuel injector and with reference to the drawings.

### BRIEF DESCRIPTION OF THE DRAWINGS

FIG. 1 shows an axial end section of a fuel injector according to the invention in a first embodiment of a nozzle needle,

FIG. 2 shows a detail of FIG. 1 in the region of an injection opening on the nozzle body,

FIG. 3 to FIG. 5 show the fuel injector according to FIG. 1 in respective partial longitudinal sections at different positions of its nozzle needle,

FIG. 6 to FIG. 9 show nozzle needle end regions of different shapes in respectively simplified partial longitudinal sections, and

FIG. 10 to FIG. 12 show further variations of the geometry of the nozzle needle in partial longitudinal sections.

In the figures, identical elements or elements having the same function are provided with the same reference numerals.

### DETAILED DESCRIPTION

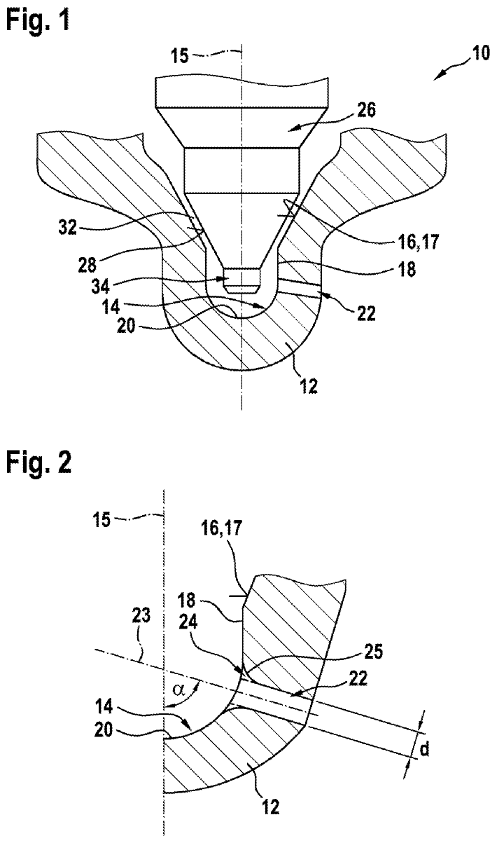

FIGS. 1 to 5 show regions of a fuel injector 10 for injecting fuel into the combustion chamber (not shown) of a self-ignition internal combustion engine. Here, the illustrated axially lower end region of the fuel injector 10 faces the combustion chamber of the internal combustion engine. In particular, the fuel injector 10 is a component of a “common rail” injection system for self-ignition internal combustion engines, the system pressure preferably being more than 2000 bar. Furthermore, the illustrated fuel injector 10 is preferably used in applications that require relatively high maximum flow rates.

The fuel injector 10 has a nozzle body 12, in which a blind hole 14 is formed. In longitudinal section, the blind hole 14 has a section 16 which is of conical design about a longitudinal axis 15 of the nozzle body 12 and forms a seat surface 17. Section 16 merges into a cylindrical section 18, which is adjoined by a rounded blind hole bottom 20. Opening into the transitional region between the cylindrical section 18 and the blind hole bottom 20 there is at least one injection opening 22, which is designed as a through hole in the nozzle body 12 and via which fuel can be injected from the nozzle body 12 into the combustion chamber of the internal combustion engine.

The injection opening 22 is arranged at an oblique angle α with respect to the longitudinal axis 15, wherein a longitudinal axis 23 of the injection opening 22 preferably intersects the transition between the cylindrical section 18 and the blind hole bottom 20 (FIG. 2).

According to the illustration of FIG. 2, provision can be made for the inlet region 24 of the injection opening 22 to be equipped with a rounded portion 25.

The diameter of the injection opening 22 in the region outside the rounded portion 25 is denoted by d.

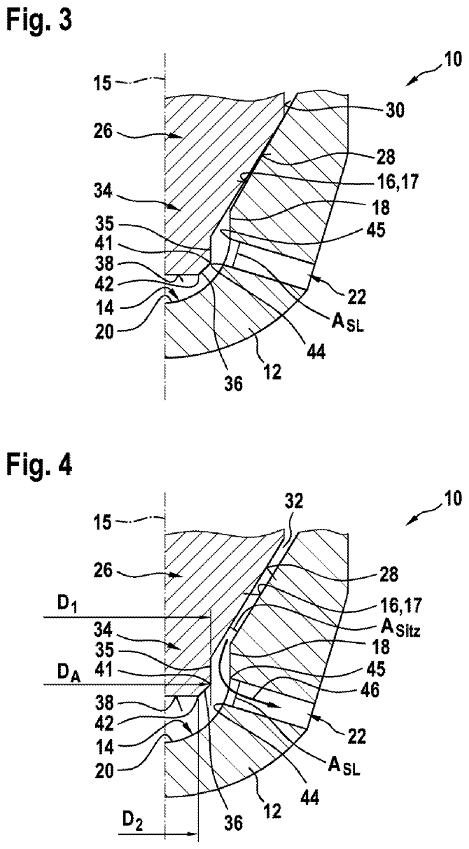

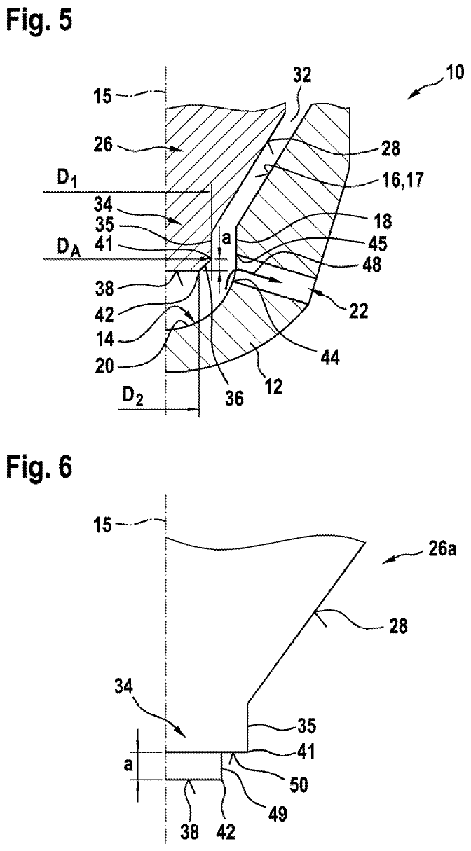

For the injection of fuel into the combustion chamber of the internal combustion engine, the nozzle body 12 described thus far interacts via the at least one injection opening 22 with a nozzle needle 26 arranged so that it can perform a stroke motion along the longitudinal axis 15. The nozzle needle 26 is moved by means of a magnetic actuator (not illustrated), for example, in a manner known per se, such that, in a lowered position, illustrated in FIG. 3, of the nozzle needle 26, the latter forms a sealing seat 30 with the nozzle body 12 or the seat surface 17 thereof in the region of a conically designed sealing surface 28 of the nozzle needle 26, in order at least indirectly to close the at least one injection opening 22. In the case of the partially or completely raised nozzle needle 26 illustrated in FIGS. 4 and 5, in contrast, an inlet gap 32 is opened in the direction of the at least one injection opening 22, enabling the fuel to be injected into the combustion chamber of the internal combustion engine.

On the side facing the blind hole bottom 20, the sealing surface 28 of the nozzle needle 26 merges into a cylindrical section 35 as part of a needle tip 34, which is in turn adjoined by a conical section 36. The end face 38 of the nozzle needle 26, which faces the blind hole bottom 20, is designed as a flat end face 38, i.e. extends perpendicularly to the longitudinal axis 15.

The transition between the cylindrical section 35 and the conical section 36 of the nozzle needle 26 forms a first edge 41 with a first diameter D₁ extending radially around the longitudinal axis 15. At the transition to the conical section 36, the end face 38 forms a second edge 42, with a second diameter D₂ extending radially around the longitudinal axis 15. In this case, the second diameter D₂ is smaller than the first diameter D₁. Furthermore, an axial distance a is formed between the two edges 41, 42, when viewed in the direction of the longitudinal axis 15. The distance a is 0.4 times to 1.6 times the diameter d of the injection opening 22 outside the inlet region 24, i.e. in the cylindrical region of the injection opening 22.

FIG. 3 illustrates the closed position of the nozzle needle 26 in the nozzle body 12. In this case, the second edge 42 is below a lower inlet edge 44 of the injection opening 22 when viewed axially in the direction of the longitudinal axis 15.

FIG. 4 illustrates a partially opened nozzle needle 26. In this case, the first edge 41 is below an upper inlet edge 45 of the injection opening 22 when viewed in the axial direction of the longitudinal axis 15. This has the effect that a primary flow 46, which passes directly from the inlet gap 32 into the region of the injection opening 22, is guided in a particularly favorable manner in terms of flow. The open position of the nozzle needle 26, which is illustrated in FIG. 4, is distinguished by the fact that the (annular) cross section A_{Sitz} in the region of the inlet gap 32 is less than the sum of the cross sections A_{SL} of the injection openings 22.

FIG. 5 illustrates the (fully) open state of the nozzle needle 26. In this case, the second edge 42 is preferably below the upper inlet edge 45 of the injection opening 22, or at most approximately 30 μm above it. Such an arrangement has the effect that a secondary flow 48, which passes from the blind hole bottom 20 into the region of the injection openings 22, produces relatively small flow separations in the region of the injection openings 22. The (fully) open state of the nozzle needle 26 is furthermore distinguished by the fact that the cross section A_{Sitz} of the inlet gap 32 is greater than the sum of the cross sections A_{SL} of the injection openings 22.

FIG. 6 illustrates a nozzle needle 26a modified with respect to FIGS. 1 to 5. This is distinguished by the fact that, instead of the conical section 36, a cylindrical section 49 is provided between the cylindrical section 35 and the end face 38. The first edge 41 is located at the transition from section 35 to the annular surface 50 connecting sections 35 and 49.

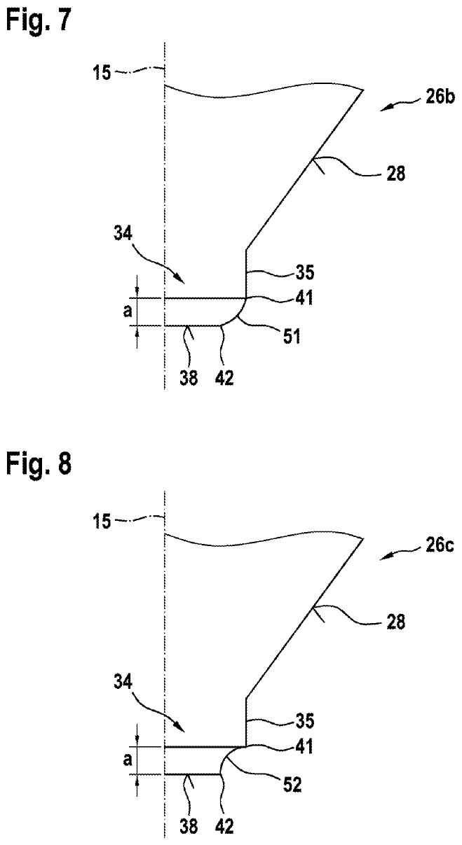

The nozzle needle 26b illustrated in FIG. 7, on the other hand, has a section 51 of convex or rounded design at the transition from the cylindrical section 35 to the (flat) end face 38.

The nozzle needle 26c illustrated in FIG. 8 has a section 52 of concave design instead of the section 51 of convex design.

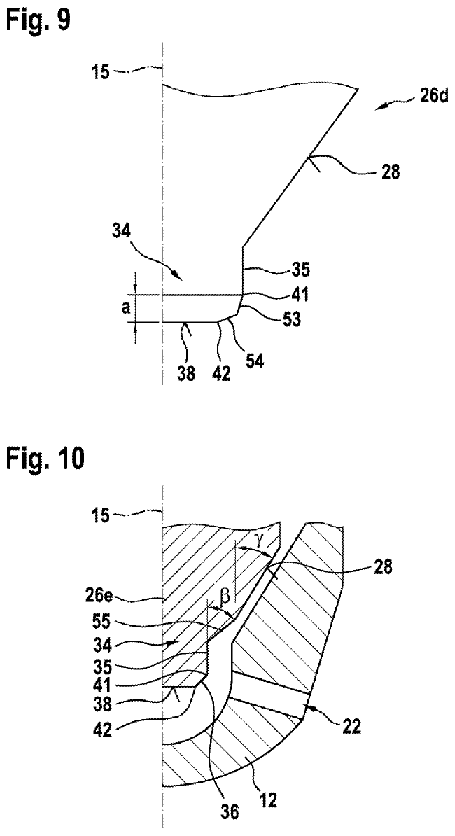

FIG. 9 illustrates the case of the nozzle needle 26d in which the transition between the cylindrical section 35 and the (flat) end face 38 is formed by two sections 53, 54 of conical design having different angles with respect to the longitudinal axis 15.

FIG. 10 illustrates a nozzle needle 26e in which a conical section 55 adjoins the sealing surface 28 in the direction of the cylindrical section 35. The section 55 of conical design has an angle β which is greater by a maximum of 8.5° than an angle γ between the sealing surface 28 and a parallel to the longitudinal axis 15.

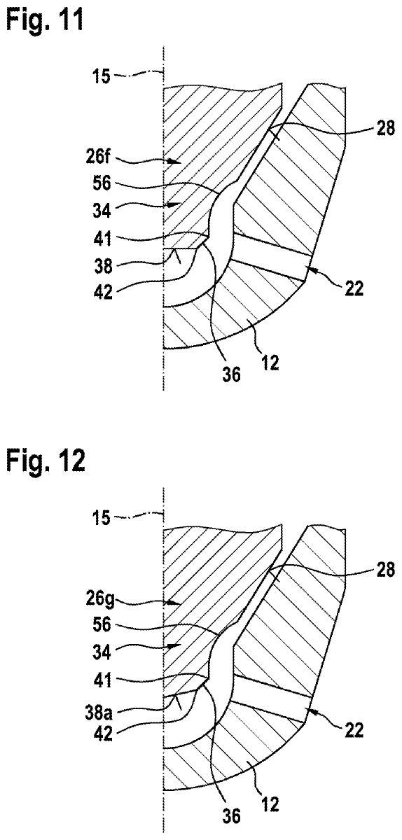

FIG. 11 illustrates a nozzle needle 26f in which the transition between the sealing surface 28 and the first edge 41 is formed by a section 56 of concave design.

Finally, FIG. 12 illustrates the case in which the nozzle needle 26g is basically shaped like nozzle needle 26f but the end face 38e is of sloping or conical design.

1. A fuel injector (10) for internal combustion engines, the fuel injector comprising
a nozzle body (12) having therein a blind hole (14), from which at least one injection opening (22) starts, and
a nozzle needle (26; 26a to 26g), which is arranged in a longitudinally movable manner in the nozzle body (12) and which has, on a side facing the blind hole (14), a sealing surface (28), by which the nozzle needle (26; 26a to 26g) interacts with a seat surface (17) of the nozzle body (12) in order to control a fuel flow to the at least one injection opening (22), and the nozzle needle having a needle tip (34), which adjoins the sealing surface (28) in a direction of the blind hole (14) and which has a first edge (41) with a first diameter (D₁) extending radially around a longitudinal axis (15), wherein a second edge (42) adjoins the first edge (41) in the direction of the blind hole bottom (20) and has a second diameter (D₂) extending radially around the longitudinal axis (15), wherein, in a lowered position of the nozzle needle (26; 26a to 26g) forming a sealing seat (30), the second edge (42) is arranged below a lower inlet edge (44) of the injection opening (22) when viewed in a direction of the longitudinal axis (15), wherein, in a partially open position of the nozzle needle (26; 26a to 26g), the first edge (41) is arranged below an upper inlet edge (45) of the injection opening (22) when viewed in the direction of the longitudinal axis (15), and wherein, in a fully open position of the nozzle needle (26; 26a to 26g), the second edge (42) is arranged above the lower inlet edge (44) of the injection opening (22) when viewed in the direction of the longitudinal axis (15),
wherein a diameter (D₁) of the nozzle needle (26; 26a to 26g) in a region of the first edge (41) is greater than a diameter (D₂) of the nozzle needle (26; 26a to 26g) in a region of the second edge (42), and wherein a distance (a) between the first and second edges (41, 42), when viewed in the direction of the longitudinal axis (15), corresponds to 0.4 times to 1.6 times a diameter (d) of the injection opening (22) in an inlet region (24) to the blind hole (14) in the non-rounded state of the inlet region (24).

2. The fuel injector as claimed in claim 1, wherein the nozzle needle (26; 26e to 26g) has at least one conical section (36; 53, 54) between the first and second edges (41, 42).

3. The fuel injector as claimed in claim 1, wherein the nozzle needle (26a) has a cylindrical section (49) between the first and second edges (41, 42).

4. The fuel injector as claimed in claim 1, wherein the nozzle needle (26b; 26c) has at least one convex section (51; 52) between the two edges (41, 42).

5. The fuel injector as claimed in claim 1, wherein the nozzle needle (26; 26a to 26e) has a cylindrical section (35) between the first edge (41) and the sealing surface (28).

6. The fuel injector as claimed in claim 5, wherein the cylindrical section (35) is adjoined in a direction of the sealing surface (28) by a section (55) of conical design having a first angle (β) with respect to the longitudinal axis (15) that is greater than a second angle (γ) between the sealing surface (28) and the longitudinal axis (15).

7. The fuel injector as claimed in claim 6, wherein the difference between the first and second angles (β, γ) is less than 8.5°.

8. The fuel injector as claimed in claim 1, wherein the nozzle needle (26f; 26g) has a concave section (56) between the first edge (41) and the sealing surface (28).

9. The fuel injector as claimed in claim 1, wherein the second edge (42) delimits a flat end face (38) of the needle tip (34).

10. The fuel injector as claimed in claim 1, wherein the needle tip (34) has a conical end face (38a) on a side of the second edge (42) which faces away from the first edge (41).

11. The fuel injector as claimed in claim 1, wherein the blind hole (14) has a cylindrical section (18) which merges into the rounded blind hole bottom (20), and wherein a transition between the cylindrical section (18) and the rounded blind hole bottom (20) is arranged between the lower and upper inlet edges (44, 45) of the injection opening (22).

12. The fuel injector as claimed in claim 1, wherein the injection opening (22) is formed with a rounded portion (25) in the inlet region (24) to the blind hole (14).

13. The fuel injector as claimed in claim 1, wherein the nozzle needle (26b; 26c) has at least one concave section (51; 52) between the two edges (41, 42).

14. The fuel injector as claimed in claim 1, wherein the blind hole (14) has a cylindrical section (18) which merges into the rounded blind hole bottom (20), wherein a transition between the cylindrical section (18) and the rounded blind hole bottom (20) is arranged between the lower and upper inlet edges (44, 45) of the injection opening (22), and wherein a longitudinal axis (23) of the injection opening (22) intersects the transition between the cylindrical section (18) and the blind hole bottom (20).
